(19) United States
(12) Patent Application Publication
(10) Pub. No.: US 2019/0172125 A1
(43) Pub. Date: Jun. 6, 2019

(54) SYSTEM AND METHOD FOR AUTHENTICATING SELLERS OF GOODS AND SERVICES USING BROADCAST TECHNOLOGY

(71) Applicant: William Danforth, River Falls, WI (US)

(72) Inventor: William Danforth, River Falls, WI (US)

(21) Appl. No.: 16/116,348

(22) Filed: Aug. 29, 2018

Related U.S. Application Data
(60) Provisional application No. 62/594,546, filed on Dec. 5, 2017.

(51) Int. Cl. G06Q 30/06; G06F 3/0481

(52) U.S. Cl. CPC G06Q 30/0643; G06F 3/04817; G06Q 30/0609

(57) ABSTRACT

A system and method that permits consumers or potential consumers to visualize and test out products in real-time with broadcasting technology. The consumer can test out how the product works, see how a service would work for them, as questions or to discover more information from the seller. This permits the seller to provide extra value for their customers and to build rapport with consumers. The system and method also assists authorities to identify and curtail Internet scams. The scammer would be identified through the broadcasting or livestreaming. This will also help consumers to trust Internet sellers more because the seller has an incentive not to scam because their personal reputation would be at risk if they were to attempt it.

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### CROSS-REFERENCE TO RELATED APPLICATIONS, IF ANY

This application claims the benefit under 35 U.S.C. § 119(e) of co-pending U.S. Provisional Patent Application Ser. No. 62/594,546, filed Dec. 5, 2017, which is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

### 1. Field

The present invention relates generally to systems and methods for potential consumers to visualize and test out products in real time with broadcasting technology.

### 2. Background Information

Due to the popularity of the Internet, large numbers of people frequently purchase goods and services from Internet platforms. E-commerce marketplaces and other Internet platforms for sellers are traditionally judged by their security and reviews. The systems and methods of the present invention may be used to improve consumer confidence and security in the products and services they are purchasing, by clearly identifying sellers and ascribing liability for the products and services they sell. When Internet sellers are identified and have liability for the products and services they sell, consumers will have increased trust in such sellers. And Internet sellers who are more trusted will more likely have increased sales.

Existing technology is believed to have significant limitations and shortcomings. For these and other reasons, a need exists for the present invention.

All US patents and patent applications, and all other published documents mentioned anywhere in this application are hereby incorporated by reference in their entirety.

### BRIEF SUMMARY

The present invention provides systems and methods which are practical, reliable, accurate and efficient, and which are believed to fulfill a need and to constitute an improvement over the background technology.

The invention provides a system and method that permits consumers or potential consumers to visualize and test out products in real-time with broadcasting technology. The consumer can test out how the product works, see how a services would work for them, ask questions or to discover more information from the seller. This permits the seller to provide extra value for their customers and to build rapport with consumers. The system and method also assists authorities to identify and curtail Internet scams. The scammer would be identified through the broadcasting or livestreaming. This will also help consumers to trust Internet sellers more because the seller has an incentive not to scam because their personal reputation would be at risk if they were to attempt it.

The systems and method of the invention permit authenticating seller identities through broadcasting and recording technologies. Along with letting consumers communicate in a plurality of ways with sellers, the consumer is able to see products before they buy them and to see how services work before they buy them.

In one aspect, the invention relates to an electronic platform comprising:

a main window;

a sub window of the main window transmitting an audiovisual stream directed to a product or service;

a title line displayed on the main window including text and/or numerical information about the product or service;

a buy button displayed on the main window which permits the platform user to purchase the product or service; and

a chat window displayed on the main window which permits the platform user to communicate with the seller or provider of the product or service.

In another aspect, the invention provides a method of conducting E commerce that promotes trust in sellers by buyers, minimizes fraud, and facilitates fraud investigations, comprising the steps, implemented by a computer or computer network, of:

a. the user opening a web browser and navigating to a website of an Internet seller or providers;

b. the consumer viewing a broadcast audiovisual presentation and a product or service is identified; and

c. using the presentation, the viewer purchases the product or service.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be better understood by those skilled in the art by reference to the following drawings.

FIG. 1 shows an embodiment of a Graphical User Interface (GUI) provided by the invention.

FIG. 2 is a flow chart of an embodiment of a method of the invention.

### DETAILED DESCRIPTION

the present invention provides a process for e-commerce marketplaces, classified webpages and other websites to improve online transactions. The invention provides a platform that enables sellers to broadcast themselves online to sell their goods or services. This helps consumers identify fraudulent sellers. It also enables authorities identify and catch fraudulent sellers. In addition, the platform enables consumers to better trust online sellers and therefore shop on these platforms more often. The livestream broadcasts may also be recorded for future use for the consumer to view. Secondarily it assists security authorities to obtain evidence against fraudulent sellers.

This internet streaming platform also lets customers chat or communicate with the seller in real time. The seller and consumer could also make appointments for livestreaming events.

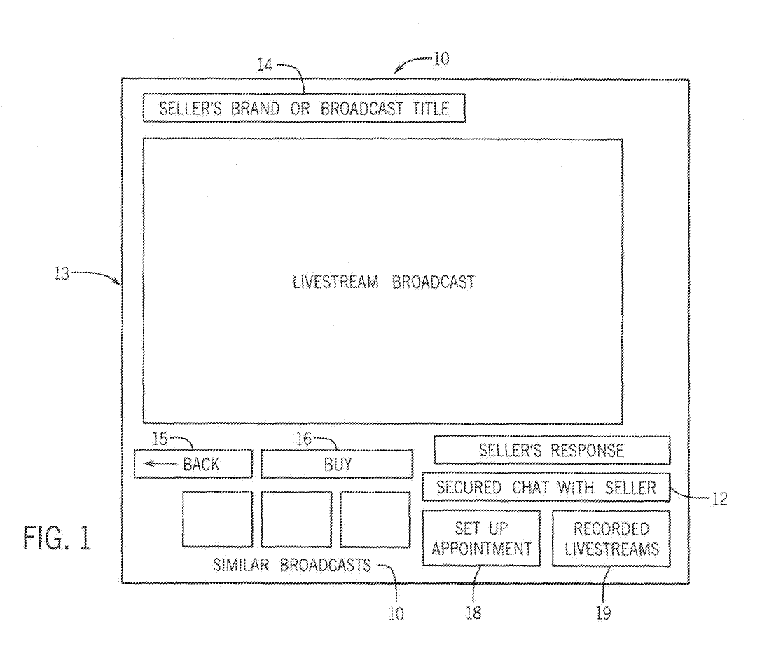

An embodiment of a GUI of the invention is shown in FIG. 1. Screen region 10 shows or provides links to “similar broadcasts.” These may be beneficial for consumers to see different brads or streams. Box 12 is a Secured Chat with a Seller. A communications text below permits consumers to ask questions, lets consumers communicate a plurality of messages to the seller, and which is private and not shown to other consumers. Window 13 is the livestream or broadcast that shows the seller. Line 14 is the title of the product or service. Button 15 is a “Back” button used to go back to the previous webpage screen. Button 16 is a “Buy” button which is used to create a transaction. Line 17 is the seller's response to the questions and messages in the chat box 12. Subscreen 18 enables the seller and consumer can set up appointments so the seller can showcase their products and service son the consumer's schedule. Control 19 enables the livestreams to be recorded for the consumer to access later if need be. Fox example, a tutorial on a product or service, or used by authorities for evidence in a criminal act or fraudulent product or service, or for consumers to build trust with seller.

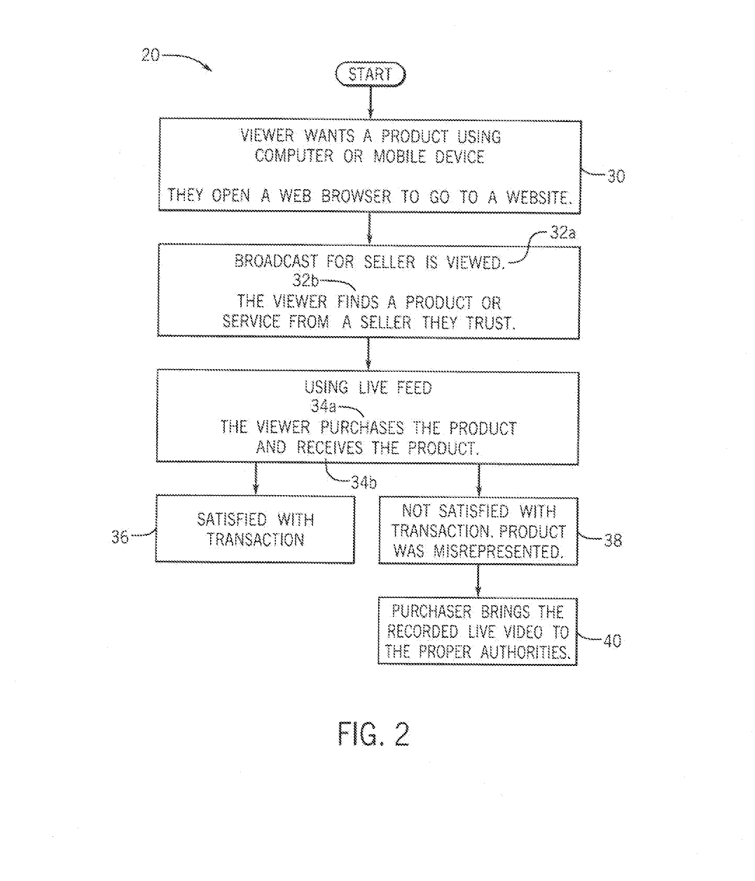

Referring to FIG. 2, an embodiment of the method of the invention is shown in a flow chart. The first step of the method 20 involves the user opening 30 a web browser and navigating to a website of an Internet seller or provider on a desktop computer, laptop, kiosk, or mobile device. Next, the consumer views 32a a broadcast audiovisual presentation, and a product or service is found 32b from the seller that is now trusted by way of viewing 32a the broadcast. Next, using the live feed, the viewer purchases 34a the product or service, and in due course receives 34b the product or service. Following this step, if the consumer is satisfied with the product or service and registers 36 satisfaction using the platform. Alternatively, if the consumer is dissatisfied with the product or service, s/he can register 38 such dissatisfaction. Further, if the transaction is fraudulent, the customer may transfer 40 information about the transaction and purported seller to a competent authority via an email, text or other communication for analysis and evidence gathering. For example, the user can save a clip, log or other record of the fraudulent material or representation.

The livestream or broadcast provided by the invention can be used by sellers in order to answer questions, take comments, feedback, make appointments and a plurality of messages by users. The seller can also use this platform to develop rapport with their consumers and build trust. The consumer can use the stream to learn information about the product and be shown exactly what the product does, how it works, learn about services that would be provided by the seller, and a plurality of other information that can be conveyed between consumer and seller and vice versa.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. An electronic platform comprising:
a main window;
a sub window of the main window transmitting an audiovisual stream directed to a product or service;
a title line displayed on the main window including text and/or numerical information about the product or service; and
a buy button displayed on the main window which permits the platform user to purchase the product or service.

2. The platform of claim 1, wherein the electronic platform includes a webpage Graphical User Interface.

3. The platform of claim 2, wherein the main window consists of the webpage, and the webpage is an E commerce webpage that promotes trust in sellers by buyers, minimizes fraud, and facilitates fraud investigations.

4. The platform of claim 2, wherein the audiovisual stream is a live stream.

5. The platform of claim 2, wherein the audiovisual stream is a pre-recorded stream.

6. The platform of claim 2, wherein the audiovisual stream consists of more than 50 percent of the area of the webpage.

7. The platform of claim 2, wherein the title line is disposed at a top of the webpage.

8. The platform of claim 2, wherein the buy button is disposed below the audiovisual stream.

9. The platform of claim 1, further comprising a chat window displayed on the main window which permits the platform user to communicate with the seller or provider of the product or service.

10. The platform of claim 9, wherein the chat window further comprises a buyers chat dialog box and a seller's response dialog box, and wherein the buyer's chat dialog box and the seller's response dialog box are disposed below the audiovisual stream.

11. The platform of claim 1, further comprising a back button.

12. The platform of claim 1, further comprising at least one similar broadcasts window.

13. The platform of claim 1, further comprising a set up appointment button.

14. The platform of claim 1, further comprising at least one pre-recorded streams windows or buttons.

15. The platform of any one of claim 11, wherein the further element is disposed at a bottom of the webpage.

16. The platform of claim 1, operated by a method comprising the steps, implemented by a computer or computer network, of:
a. the user opening a web browser and navigating to a website of an Internet seller or provider;
b. the consumer views a broadcast audiovisual presentation, and a product or service is identified;
c. using the live feed, the viewer purchases the product or service.

17. The platform of claim 16, wherein the method further comprises the steps of:
a. after receiving the product or service, if the consumer is satisfied with the product or service, the consumer registers satisfaction using the platform,
b. alternatively, if the consumer is dissatisfied with the product or service, the consumer registers dissatisfaction using the platform.

18. The platform of claim 17, wherein the method further comprises the step of, if the transaction is fraudulent, the customer transfers information about the transaction to law enforcement via an email or text from the platform.

19. An electronic, E commerce webpage that promotes trust in sellers by buyers, minimizes fraud, and facilitates fraud investigations, comprising:
a. a main window;
b. a sub window of the main window transmitting an audiovisual stream directed to a product or service, the sub window consisting of more than 50 percent of the area of the webpage;
c. a title line displayed on the main window including text and/or numerical information about the product or service, the title line being disposed at the top of the webpage;
d. a buy button displayed on the main window which permits the platform user to purchase the product or service, the buy button being disposed below the sub window;
e. a chat window displayed on the main window which permits the platform user to communicate with the seller or provider of the product or service, the chat window being disposed below the sub window, and including (i) a buyer's chat dialog box, and (ii) a seller's response dialog box;
g. at least one similar broadcasts window;
h. a set up appointment button; and
i. at least one pre-recorded streams windows or buttons.

20. A method of conducting E commerce that promotes trust in sellers by buyers, minimizes fraud, and facilitates fraud investigations, comprising the steps, implemented by a computer or computer network, of:
a. the user opening a web browser and navigating to a website of an internet seller or provider;
b. the consumer viewing a broadcast audiovisual presentation and a product or service is identified; and
c. using the presentation, the viewer purchases the product or service.
